(19) United States
(12) Patent Application Publication
(10) Pub. No.: US 2016/0081100 A1
(43) Pub. Date: Mar. 17, 2016

(54) DATA TRANSMISSION METHOD AND DEVICE

(71) Applicant: HUAWEI DEVICE CO., LTD, Shenzhen (CN)

(72) Inventors: Zhenguo DU, Shenzhen (CN); Guiming Shu, Shenzhen (CN); Su Lu, Shenzhen (CN)

(73) Assignee: HUAWEI DEVICE CO, LTD., Shenzhen (CN)

(21) Appl. No.: 14/947,205

(22) Filed: Nov. 20, 2015

Related U.S. Application Data
(63) Continuation of application No. PCT/CN2014/078094, filed on May 22, 2014.

(30) Foreign Application Priority Data
May 22, 2013 (CN) 201310191470.6

(51) Int. Cl. H04W 72/08; H04W 74/00; H04W 52/24; H04W 76/02; H04W 28/12

(52) U.S. Cl. CPC H04W 72/082; H04W 76/02; H04W 28/12; H04W 52/24; H04W 74/002

(57) ABSTRACT

The present invention discloses a data transmission method and device. The method includes: receiving, by a device in a first BSS, a data frame sent by a device in a second BSS, where the data frame sent by the device in the second BSS includes a Preamble sequence and a MAC frame; transmit power of the Preamble sequence is first power; transmit power of the MAC frame is second power; and the first power is higher than the second power; if the data frame received by the device in the first BSS includes the Preamble sequence but does not include the MAC frame, setting a NAV value according to a SIG field in the Preamble sequence; and transmitting data according to the NAV value.

### CROSS-REFERENCE TO RELATED APPLICATIONS

This application is a continuation of International Application No. PCT/CN2014/078094, filed on May 22, 2014, which claims priority to Chinese patent application No. 201310191470.6, filed on May 22, 2013, both of which are incorporated herein by reference in their entireties.

### TECHNICAL FIELD

The present invention relates to the communications field, and in particular, to a data transmission method and device.

### BACKGROUND

As a term in WLAN (Wireless Local Area Network, wireless local area network), BSS (Basic Service Set, basic service set) is used to describe a group of mobile devices communicating with each other in an 802.11 WLAN. A BSS generally includes one AP (Access Point, access point) and several STAs (Station, station). The AP and the STA usually perform data transmission by using their respective normal transmit power. The normal transmit power of the AP is a fixed value, but the normal transmit power of the STA is not a fixed value and is determined by a power attenuation situation of data sent by an AP communicating with the STA to the STA. Generally, a longer distance between the AP and the STA that communicate with each other indicates greater power attenuation and larger transmit power used by the STA to communicate with the AP. A coverage area of each BSS is determined by the normal transmit power of the AP in the BSS. Because normal transmit power of APs in different BSSs is different, coverage areas of the BSSs may also be different. In specific implementation, there may be such a case that multiple short range BSSs may exist in a coverage area of one long range BSS, that is, the coverage area of the long range BSS overlaps coverage areas of the short range BSSs. In this case, if a device (AP or STA) in the long range BSS and a device (AP or STA) in the short range BSS simultaneously perform data transmission, mutual interference between transmission of the two devices occurs, causing a transmission failure. Therefore, data transmission performed by the device in the long range BSS and the device in the short range BSS needs to be controlled to prevent occurrence of a conflict.

There is a data transmission method in the prior art, and the method includes: performing, by a device in a basic service set, physical carrier sense on a channel, that is, CCA (Clear Channel Assessment, clear channel assessment), to obtain a status of the channel; detecting a data frame sent by a device in another basic service set, so as to perform virtual carrier sense on the channel, and setting, according to a Duration (duration) field in a frame header of a MAC (Medium Access Control, Medium Access Control) frame in the data frame, a NAV (Network Allocation Vector, network allocation vector) value used to indicate a transmission time of the MAC frame; and if the status of the channel is idle and the NAV value is 0, contending, by the device, for the channel and sending the data frame; otherwise, skipping sending, by the device, the data frame.

In a process of implementing the present invention, the inventor finds that at least the following problem exists in the prior art:

In a case in which the coverage area of the long range BSS overlaps the coverage area of the short range BSS, because transmit power of the device in the short range BSS is small, when the device in the long range BSS is far away from the device that is in the short range BSS and that is transmitting data, the device in the long range BSS possibly cannot sense a data frame sent by the device in the short range BSS. At this time, if the device in the long range BSS also starts to send a data frame, interference is caused to data transmission of the device in the short range BSS, resulting in a failure of the data transmission of the device in the short range BSS. If the transmit power of the device in the short range BSS is increased, although interference caused by data frame transmission of the device in the long range BSS can be avoided, concurrent data transmission of a device in a short range BSS that does not overlap the short range BSS is also suppressed, further affecting an overall throughput of a network.

### SUMMARY

To resolve a problem in the prior art that a device in a long range BSS cannot learn that a device in a short range BSS is transmitting data, and interference may be caused to it or concurrent transmission of the device in the short range BSS may be suppressed, embodiments of the present invention provide a data transmission method and device. The technical solutions are as follows:

According to an aspect, an embodiment of the present invention provides a data transmission method, where the method includes:

receiving, by a device in a first basic service set, a data frame sent by a device in a second basic service set, where the data frame sent by the device in the second basic service set includes a preamble sequence and a Medium Access Control frame; transmit power of the preamble sequence is first power; transmit power of the Medium Access Control frame is second power; and the first power is higher than the second power;

if the data frame received by the device in the first basic service set includes the preamble sequence but does not include the Medium Access Control frame, setting a network allocation vector value according to a signal field in the preamble sequence; and

transmitting data according to the network allocation vector value.

Optionally, the setting a network allocation vector value according to a signal field in the preamble sequence includes:

obtaining, from the signal field, a frame length and a transmission rate of the Medium Access Control frame;

calculating a transfer time of the Medium Access Control frame according to the frame length and the transmission rate of the Medium Access Control frame; and

setting the network allocation vector value according to the transfer time of the Medium Access Control frame.

Preferably, the calculating a transfer time of the Medium Access Control frame according to the frame length and the transmission rate of the Medium Access Control frame includes:

determining a corresponding frame of the Medium Access Control frame according to an acknowledgement indication field in the signal field; and

if the response frame of the Medium Access Control frame is an acknowledgement frame, calculating the transfer time according to the following formula:

T=T_{PSDU}+T_{SIFS}+T_{ACK}; or

if the response frame of the Medium Access Control frame is a block acknowledgement frame, calculating the transfer time according to the following formula:

T=T_{PSDU}+2×T_{SIFS}+T_{BAR+BA}; or

if there is no acknowledgement response for the Medium Access Control frame, calculating the transfer time according to the following formula:

T=T_{PSDU}; or

if the response frame of the Medium Access Control frame is a frame other than the acknowledgement frame, a Clear To Send frame, and the block acknowledgement frame, calculating the transfer time according to the following formula:

T=T_{PSDU}+T_{SIFS}+T_{MAX}_{_{—}}_{PSDU}; where

T_{PSDU} is an actual transfer time of the Medium Access Control frame; T_{SIFS} is a short interframe space; T_{ACK} is a transfer time of the acknowledgement frame; T_{BAR+BA} is a transfer time of a block acknowledgement request frame and the block acknowledgement frame; and T_{MAX}_{_{—}}_{PSDU} is a time for transmitting a maximum allowed Medium Access Control frame.

Optionally, when normal transmit power of an access point in the first basic service set is higher than a threshold, the network allocation vector value includes a first network allocation vector value, where the setting a network allocation vector value according to a signal field in the preamble sequence includes:

setting the first network allocation vector value according to the signal field in the preamble sequence; and

the method further includes:

if the data frame received by the device in the first basic service set includes the preamble sequence and the Medium Access Control frame, setting the first network allocation vector value according to a duration field in a frame header of the Medium Access Control frame.

Optionally, when normal transmit power of an access point in the first basic service set is lower than a threshold, the network allocation vector value includes a first network allocation vector value and a second network allocation vector value, where the method further includes:

if the data frame received by the device in the first basic service set includes the preamble sequence and the Medium Access Control frame, setting the first network allocation vector value according to a duration field in a frame header of the Medium Access Control frame; and

the setting a network allocation vector value according to a signal field in the preamble sequence includes:

setting the second network allocation vector value according to the signal field in the preamble sequence.

Optionally, when the data frame received by the device in the first basic service set includes the preamble sequence and the Medium Access Control frame, before the setting the first network allocation vector value according to a duration field in a frame header of the Medium Access Control frame, the method further includes:

if the Medium Access Control frame can be parsed, setting the first network allocation vector value according to the duration field in the frame header of the Medium Access Control frame; or

if the Medium Access Control frame cannot be parsed, setting the first network allocation vector value according to the signal field in the preamble sequence.

Optionally, the transmitting data according to the network allocation vector value includes:

if the first network allocation vector value is greater than 0, skipping sending the data frame; or

if the first network allocation vector value is 0 and the second network allocation vector value is 0, sending the preamble sequence at the first power and sending the Medium Access Control frame at the second power.

Preferably, the first power equals the sum of the second power and a predetermined value, where the predetermined value is greater than 0.

Preferably, the sending the preamble sequence at the first power further includes:

using a bit in the signal field to indicate that the preamble sequence is sent at the first power.

Optionally, the transmitting data according to the network allocation vector value further includes:

if the first network allocation vector value is 0 and the second network allocation vector value is greater than 0 and a time required for the second network allocation vector value to decrease to 0 is greater than or equal to a data transmission time of the device in the first basic service set, sending the data frame at the second power; or

if the first network allocation vector value is 0 and the second network allocation vector value is greater than 0 and a time required for the second network allocation vector value to decrease to 0 is less than a data transmission time of the device in the first basic service set, after the second network allocation vector value decreases to 0, sending the preamble sequence at the first power, and sending the Medium Access Control frame at the second power.

Optionally, before the transmitting data according to the network allocation vector value, the method further includes:

determining whether a long range basic service set exists around the device in the first basic service set, where normal transmit power of an access point in the long range basic service set is higher than the threshold; and

when the long range basic service set does not exist around the device in the first basic service set, sending the data frame at the second power; or

when the long range basic service set exists around the device in the first basic service set, transmitting the data according to the network allocation vector value.

Optionally, the determining whether a long range basic service set exists around the device in the first basic service set includes:

receiving a beacon frame broadcasted by each access point and acquiring normal transmit power of each access point from the beacon frame;

comparing the normal transmit power of each access point with the threshold; and

if normal transmit power of at least one access point is higher than the threshold, determining that the long range basic service set exists around the device in the first basic service set; otherwise, determining that the long range basic service set does not exist around the device in the first basic service set.

Optionally, the method further includes:

performing physical carrier sense on a channel to obtain a status of the channel; and

the transmitting data according to the network allocation vector value includes:

transmitting the data according to the status of the channel and the network allocation vector value.

Optionally, before the setting a network allocation vector value according to a signal field in the preamble sequence, the method further includes:

determining whether the device in the first basic service set is a device in the long range basic service set or a device in a short range basic service set.

Specifically, the determining whether the device in the first basic service set is a device in the long range basic service set or a device in a short range basic service set includes:

when normal transmit power of the device in the first basic service set is higher than the threshold, determining that the device in the first basic service set is a device in the long range basic service set; or

when normal transmit power of the device in the first basic service set is lower than the threshold, determining that the device in the first basic service set is a device in a short range basic service set, where the device in the short range basic service set acquires the threshold from a beacon frame broadcasted by an access point in the long range basic service set.

According to another aspect, an embodiment of the present invention provides a data transmission device, where the device includes:

a receiving module, configured to receive a data frame sent by a device in a second basic service set, where the data frame sent by the device in the second basic service set includes a preamble sequence and a Medium Access Control frame; transmit power of the preamble sequence is first power; transmit power of the Medium Access Control frame is second power; and the first power is higher than the second power;

a network allocation vector setting module, configured to: when the data frame received by the receiving module includes the preamble sequence but does not include the Medium Access Control frame, set a network allocation vector value according to a signal field in the preamble sequence; and

a transmission module, configured to transmit data according to the network allocation vector value that is set by the network allocation vector setting module.

Optionally, the network allocation vector setting module includes:

an obtaining unit, configured to obtain, from the signal field, a frame length and a transmission rate of the Medium Access Control frame;

a calculating unit, configured to calculate a transfer time of the Medium Access Control frame according to the frame length and the transmission rate of the Medium Access Control frame and obtained by the obtaining unit; and

a setting unit, configured to set the network allocation vector value according to the transfer time of the Medium Access Control frame obtained by the calculating unit.

Preferably, the calculating unit is configured to:

determine a response frame of the Medium Access Control frame according to an acknowledgement indication field in the signal field; and

when the response frame of the Medium Access Control frame is an acknowledgement frame, calculate the transfer time according to the following formula:

T=T_{PSDU}+T_{SIFS}+T_{ACK}; or

when the response frame of the Medium Access Control frame is a block acknowledgement frame, calculate the transfer time according to the following formula:

T=T_{PSDU}+2×T_{SIFS}+T_{BAR+BA}; or

when there is no acknowledgement response for the Medium Access Control frame, calculate the transfer time according to the following formula:

T=T_{PSDU}; or

when the response frame of the Medium Access Control frame is a frame other than the acknowledgement frame, a Clear To Send frame, and the block acknowledgement frame, calculate the transfer time according to the following formula:

T=T_{PSDU}+T_{SIFS}+T_{MAX}_{_{—}}_{PSDU}; where

T_{PSDU} is an actual transfer time of the Medium Access Control frame; T_{SIFS} is a short interframe space; T_{ACK} is a transfer time of the acknowledgement frame; T_{BAR+BA} is a transfer time of a block acknowledgement request frame and the block acknowledgement frame; and T_{MAX}_{_{—}}_{PSDU} is a time for transmitting a maximum allowed Medium Access Control frame.

Optionally, the network allocation vector setting module is further configured to:

when normal transmit power of an access point in a first basic service set is higher than a threshold, and the data frame received by the receiving module includes the preamble sequence but does not include the Medium Access Control frame, set a first network allocation vector value according to the signal field in the preamble sequence; or

when normal transmit power of an access point in a first basic service set is higher than a threshold, and the data frame received by the receiving module includes the preamble sequence and the Medium Access Control frame, set a first network allocation vector value according to a duration field in a frame header of the Medium Access Control frame.

Optionally, the network allocation vector setting module is further configured to:

when normal transmit power of an access point in a first basic service set is lower than a threshold, and the data frame received by the receiving module includes the preamble sequence and the Medium Access Control frame, set a first network allocation vector value according to a duration field in a frame header of the Medium Access Control frame; or

when normal transmit power of an access point in a first basic service set is lower than a threshold, and the received data frame includes the preamble sequence but does not include the Medium Access Control frame, set a second network allocation vector value according to the signal field in the preamble sequence.

Optionally, the network allocation vector setting module is further configured to:

when the data frame received by the receiving module includes the preamble sequence and the Medium Access Control frame, before the setting a first network allocation vector value according to a duration field in a frame header of the Medium Access Control frame,

when the Medium Access Control frame can be parsed, set the first network allocation vector value according to the duration field in the frame header of the Medium Access Control frame; or

when the Medium Access Control frame cannot be parsed, set the first network allocation vector value according to the signal field in the preamble sequence.

Optionally, the transmission module is configured to:

when the first network allocation vector value is greater than 0, skip sending the data frame; or

when the first network allocation vector value is 0 and the second network allocation vector value is 0, send the preamble sequence at the first power and send the Medium Access Control frame at the second power.

Optionally, the transmission module is configured to:

when the first network allocation vector value is 0 and the second network allocation vector value is 0, send the preamble sequence by using the sum of the second power and a predetermined value, and send the Medium Access Control frame at the second power, where the predetermined value is greater than 0.

Preferably, the transmission module is further configured to:

use a bit in the signal field to indicate that the preamble sequence is sent at the first power.

Optionally, the transmission module is further configured to:

when the first network allocation vector value is 0 and the second network allocation vector value is greater than 0 and a time required for the second network allocation vector value to decrease to 0 is greater than or equal to a data transmission time of the device in the first basic service set, send the data frame at the second power; or

when the first network allocation vector value is 0 and the second network allocation vector value is greater than 0 and a time required for the second network allocation vector value to decrease to 0 is less than a data transmission time of the device in the first basic service set, after the second network allocation vector value decreases to 0, send the preamble sequence at the first power, and send the Medium Access Control frame at the second power.

Optionally, the device further includes:

a determining module, configured to determine whether a long range basic service set exists around the device, where normal transmit power of an access point in the long range basic service set is higher than the threshold;

when the long range basic service set does not exist around the device, the transmission module is configured to send the data frame at the second power; or

when the long range basic service set exists around the device, the transmission module is configured to transmit the data according to the network allocation vector value that is set by the network allocation vector setting module.

Optionally, the determining module includes:

an acquiring unit, configured to receive a beacon frame broadcasted by each access point, and acquire normal transmit power of each access point from the beacon frame;

a comparing unit, configured to compare, with the threshold, the normal transmit power of the access point acquired by the acquiring unit; and, when normal transmit power of at least one access point is higher than the threshold, determine that the long range basic service set exists around the device; otherwise, determine that the long range basic service set does not exist around the device.

Optionally, the device further includes:

a clear channel assessment module, configured to perform physical carrier sense on a channel to obtain a status of the channel; where

the transmission module is configured to:

transmitting the data according to the status of the channel and the network allocation vector value.

Optionally, the device further includes:

the determining module, configured to determine whether the device is a device in the long range basic service set or a device in a short range basic service set.

Optionally, the determining module is configured to:

when normal transmit power of the device is higher than the threshold, determine that the device is a device in the long range basic service set; or

when normal transmit power of the device is lower than the threshold, determine that the device is a device in the short range basic service set, where the device in the short range basic service set acquires the threshold from a beacon frame broadcasted by an access point in the long range basic service set.

Beneficial effects brought by the technical solutions provided in the embodiments of the present invention are as follows:

A NAV value used to indicate a transfer time of a MAC frame is set according to a SIG field in a Preamble sequence, and the Preamble sequence is sent by a device in a second BSS by using first power, where the first power is higher than second power used for sending the MAC frame, so as to enable a device in a first BSS to obtain the transfer time of the MAC frame. When the first BSS is a long range BSS, the device in the first BSS (long range BSS) may receive the Preamble sequence sent by the device in the second BSS (short range BSS), so as to obtain a data transmission time of the device in the second BSS and set the NAV value according to the data transmission time; therefore, when data is transmitted according to the NAV value, no interference is caused to data transmission of the device in the second BSS, and further, the data transmission of the device in the second BSS does not fail. When the first BSS is a short range BSS, the device in the second BSS sends the Preamble sequence at the first power, and sends the MAC frame at the second power, where the first power is higher than the second power; therefore, the device in the second BSS suppresses data transmission of the device in the first BSS (short range BSS) only when sending the Preamble sequence, and does not suppress data transmission of the device in the first BSS when sending the MAC frame, thereby avoiding a problem in the prior art that an increase in transmit power of an entire data frame results in suppression of concurrent data transmission of devices in two short range BSSs (the first BSS and the second BSS) that do not overlap.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of an application scenario of an embodiment of the present invention;

FIG. 2 is a flowchart of a data transmission method according to Embodiment 1 of the present invention;

FIG. 3 is a flowchart of a data transmission method according to Embodiment 2 of the present invention;

FIG. 4 is a schematic structural diagram of a data frame according to Embodiment 2 of the present invention;

FIG. 5 is a schematic structural diagram of a signal field in an 802.11 physical layer according to Embodiment 2 of the present invention;

FIG. 6 is a schematic structural diagram of a signal field in an 802.11 ah physical layer of 1 MHz according to Embodiment 2 of the present invention;

FIG. 7 is a schematic structural diagram of a signal field in an 802.11ah physical layer of multiple users according to Embodiment 2 of the present invention;

FIG. 8 is a flowchart of a data transmission method according to Embodiment 3 of the present invention;

FIG. 9 is a schematic structural diagram of a data transmission device according to Embodiment 4 of the present invention;

FIG. 10 is a schematic structural diagram of a data transmission device according to Embodiment 5 of the present invention;

FIG. 11 is a schematic structural diagram of a data transmission device according to Embodiment 6 of the present invention; and

FIG. 12 is a schematic structural diagram of a specific implementation manner of a data transmission device according to Embodiment 7 of the present invention.

### DESCRIPTION OF EMBODIMENTS

To make the objectives, technical solutions, and advantages of the present invention clearer, the following further describes the embodiments of the present invention in detail with reference to the accompanying drawings.

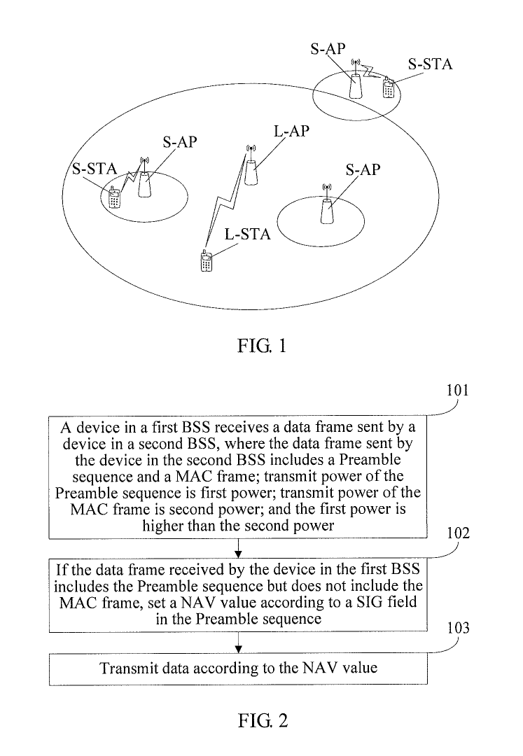

The following first describes an application scenario of an embodiment of the present invention with reference to FIG. 1. The application scenario is only an example and does not constitute a limitation on the present invention. As previously mentioned, according to different coverage areas, BSSs may be classified into a long range BSS and a short range BSS. In this embodiment of the present invention, the long range BSS refers to a BSS in which normal transmit power of an AP is higher than the threshold, and the short range BSS refers to a BSS in which normal transmit power of an AP is lower than the threshold. The threshold may be manually set according to an actual situation. As shown in FIG. 1, the long range BSS includes a long range AP L-AP and a long range STA L-STA that communicate with each other, where normal transmit power used by the long range AP L-AP to send data to the long range STA L-STA is higher than the threshold, and a maximum value of normal transmit power used by the long range STA L-STA to send data to the long range AP L-AP is the normal transmit power of the long range AP L-AP. The short range BSS includes a short range AP S-AP and a short range STA S-STA that communicate with each other, where normal transmit power used by the short range AP S-AP to send data to the short range STA S-STA is lower than the threshold, and a maximum value of normal transmit power used by the short range STA S-STA to send data to the short range AP S-AP is the normal transmit power of the short range AP S-AP.

In FIG. 1, ellipses indicate coverage areas of the BSSs. As shown in FIG. 1, three short range BSSs exist in the coverage area of one long range BSS. The BSSs whose coverage areas overlap may be referred to as an OBSS (Overlapping Basic Service Set, overlapping basic service set). In FIG. 1, coverage areas of two short range BSSs are located within the coverage area of the long range BSS, and the coverage area of the third short range BSS partially overlaps the coverage area of the long range BSS. It is easy to figure out that, both a case in which the coverage area of the short range BSS is located within the coverage area of the long range BSS, and a case in which the coverage area of the short range BSS partially overlaps the coverage area of the long range BSS, pertain to the BSSs whose coverage areas overlap in the embodiments of the present invention.

### Embodiment 1

An embodiment of the present invention provides a data transmission method, applied to the foregoing BSSs whose coverage areas overlap. The method in this embodiment is executed by a device (which may be an AP or a STA) in a first BSS. Referring to FIG. 2, the method includes:

Step 101: A device in a first BSS receives a data frame sent by a device in a second BSS.

In an embodiment, the first BSS may be a long range BSS or a short range BSS. The second BSS may be a short range BSS, where normal transmit power of an AP in the short range BSS, that is, normal transmit power of a short range AP, is lower than a threshold. The data frame sent by the device in the second BSS includes a Preamble (preamble) sequence and a MAC frame. Transmit power of the Preamble sequence is first power, and transmit power of the MAC frame is second power. That is, the device in the second BSS sends the Preamble sequence of the data frame at the first power, and sends the MAC frame of the data frame at the second power. The first power is higher than the second power.

In specific implementation, the second power may be normal transmit power of a device in a BSS. For a device in the long range BSS, the second power is higher than the threshold; for a device in the short range BSS, the second power is lower than the threshold.

Step 102: If the data frame received by the device in the first BSS includes the Preamble sequence but does not include the MAC frame, set a NAV value according to a SIG (Signal, signal) field in the Preamble sequence.

In an implementation manner of this embodiment, that is, in a case in which the first BSS is a long range BSS, the NAV value is a first NAV value, where the first NAV value is set according to a Duration field in a frame header in the MAC frame or set according to the SIG field in the Preamble sequence (for details, refer to Embodiment 2). In another implementation manner of this embodiment, that is, in a case in which the first BSS is a short range BSS, the NAV value includes a first NAV value and a second NAV value, where the first NAV value is set according to a Duration field in a frame header in the MAC frame or set according to the SIG field in the Preamble sequence, and the second NAV value is set according to the SIG field in the Preamble sequence (for details, refer to Embodiment 3).

Step 103: Transmit data according to the NAV value.

In this embodiment of the present invention, by setting, according to a SIG field in a Preamble sequence, a NAV value used to indicate a transfer time of a MAC frame, the Preamble sequence is sent by a device in a second BSS by using first power, where the first power is higher than second power used for sending the MAC frame, so as to enable a device in a first BSS to obtain the transfer time of the MAC frame. When the first BSS is a long range BSS, the device in the first BSS (long range BSS) can receive the Preamble sequence sent by the device in the second BSS (short range BSS), so as to obtain a data transmission time of the device in the second BSS and set the NAV value according to the data transmission time; therefore, when data is transmitted according to the NAV value, no interference is caused to data transmission of the device in the second BSS, and further, the data transmission of the device in the second BSS does not fail. When the first BSS is a short range BSS, the device in the second BSS sends the Preamble sequence at the first power, and sends the MAC frame at the second power, where the first power is higher than the second power; therefore, the device in the second BSS suppresses data transmission of the device in the first BSS (short range BSS) only when sending the Preamble sequence, and does not suppress data transmission of the device in the first BSS when sending the MAC frame, thereby avoiding a problem in the prior art that an increase in transmit power of an entire data frame results in suppression of concurrent data transmission of devices in two short range BSSs (the first BSS and the second BSS) that do not overlap.

### Embodiment 2

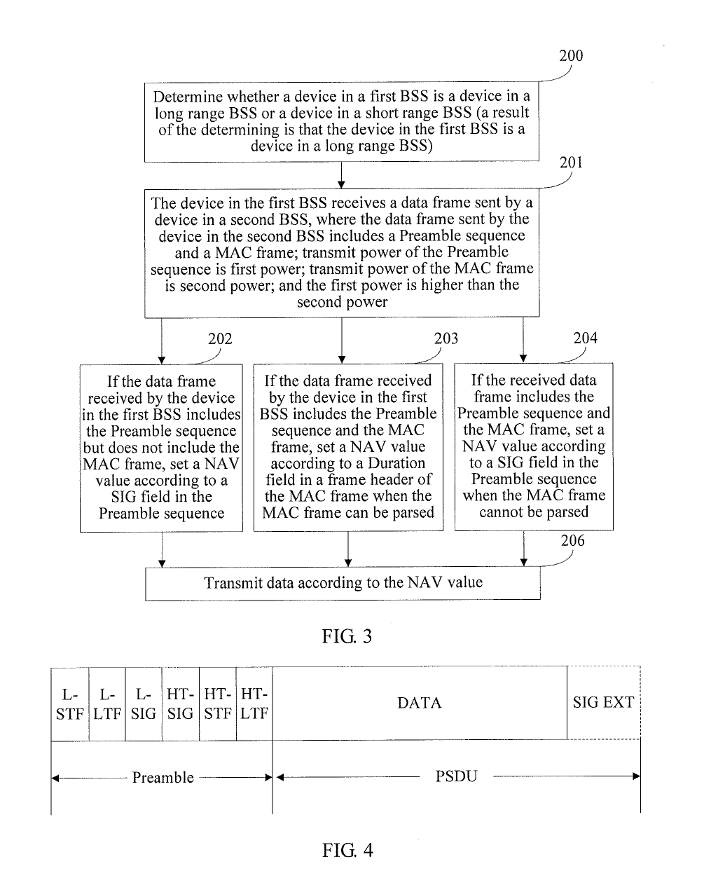

An embodiment of the present invention describes, by using an example in which a device in a first BSS is a device in a long range BSS, the data transmission method provided in Embodiment 1 of the present invention. The method in this embodiment is executed by the device (which may be an AP or a STA) in the first BSS. Referring to FIG. 3, the method includes:

Step 201: A device in a first BSS receives a data frame sent by a device in a second BSS.

In an embodiment, the second BSS may be a short range BSS, where normal transmit power of an AP in the short range BSS is lower than a threshold. The data frame sent by the device in the second BSS includes a Preamble sequence and a MAC frame. Transmit power of the Preamble sequence is first power, and transmit power of the MAC frame is second power. That is, the device in the second BSS sends the Preamble sequence of the data frame at the first power, and sends the MAC frame of the data frame at the second power. The first power is higher than the second power.

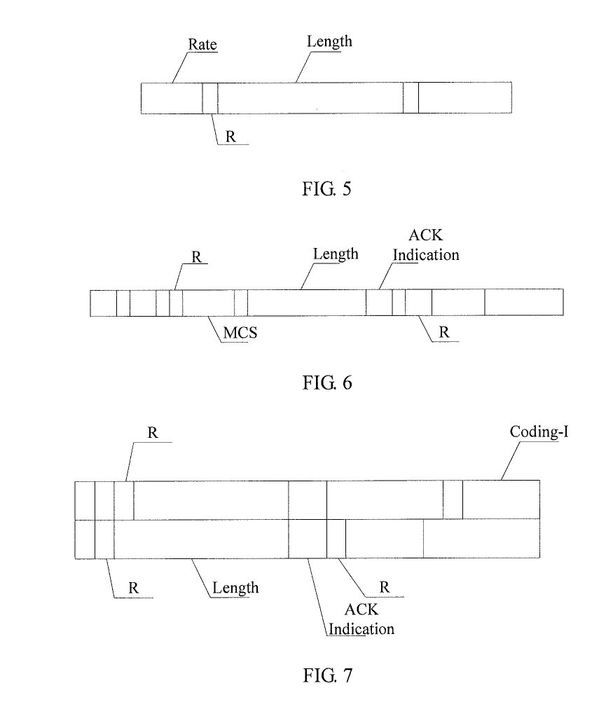

FIG. 4 shows a frame structure of a data frame in an embodiment of the present invention. The data frame is also referred to as a PPDU (Physical layer convergence procedure Protocol Data Unit, physical layer convergence procedure protocol data unit), including a Preamble sequence and a PSDU (Physical layer convergence procedure Service Data Unit, physical layer convergence procedure service data unit). The Preamble sequence includes a field that can be parsed by a device earlier than 802.11 and is used to be compatible with the device earlier than 802.11, such as an L-STF (Legacy Short Training Field, legacy short training field), an L-LTF (Legacy Long Training Field, legacy long training field), or an L-SIG (Legacy Signal, legacy signal) field, and a field that cannot be parsed by the device earlier than 802.11 and is used to indicate Preamble sequence information of 802.11, such as an HT-SIG (High Throughput Signal, high throughput signal) field, an HT-STF (High Throughput Short Training Field, high throughput short training field), or an HT-LTF (High Throughput Long Training Field, high throughput long training field). The PSDU, that is, the MAC frame, includes a DATA (data) field and a SIG EXT (Signal Extension, signal extension) field. The frame header of the MAC frame is located in the DATA field, and the frame header of the MAC frame includes the Duration field and another field (not shown in the figure). The SIG field in the Preamble sequence, that is, the L-SIG field, includes a Length (length) field used to indicate a length of transmitted data, and a Rate (rate) field used to indicate a transmission rate (refer to a schematic diagram of a SIG field in an 802.11 physical layer shown in FIG. 5) or an MCS (Modulation and Coding Scheme, modulation and coding scheme) field (refer to a schematic diagram of a SIG field in an 802.11ah physical layer of 1 MHz shown in FIG. 6) or a Coding-I (first coding) field (refer to a schematic diagram of a SIG field in an 802.11ah physical layer of multiple users shown in FIG. 7). The SIG field in the Preamble sequence may further include an ACK (Acknowledgement) Indication (indication) field used to indicate types of response frames (refer to FIG. 6 and FIG. 7) and an R (reserved, reserved) bit (refer to FIG. 5, FIG. 6, and FIG. 7).

Step 202: If the data frame received by the device in the first BSS includes the Preamble sequence but does not include the MAC frame, set a NAV value according to a SIG field in the Preamble sequence.

It should be noted that, in this embodiment, the NAV value includes a first NAV value.

In an implementation manner of this embodiment, step 202 may include:

Step 2021: Obtain, from the SIG field, a frame length and a transmission rate that are of the MAC frame.

Optionally, step 2021 may include: obtaining the transmission rate of the MAC frame from a field indicating a transmission rate in the SIG field; obtaining a length of the DATA field from a field indicating a length of transmitted data in the SIG field; and obtaining the frame length of the MAC frame according to the length of the DATA field.

Step 2022: Calculate a transfer time of the MAC frame according to the frame length and the transmission rate that are of the MAC frame.

Optionally, step 2022 may include: calculating the transfer time according to the following formula:

T=L/V, where

L indicates the frame length of the MAC frame and V indicates the transmission rate of the MAC frame.

Preferably, step 2022 may include:

determining the response frame of the MAC frame according to the ACK Indication (acknowledgement indication) field in the SIG field; and

if the response frame of the MAC frame is an ACK frame, that is, ACK Indication=00, calculating the transfer time according to the following formula:

T=T_{PSDU}+T_{SIFS}+T_{ACK}; or

if the response frame of the MAC frame is a BA (Block Acknowledgement, block acknowledgement) frame, that is, ACK Indication=01, calculating the transfer time according to the following formula:

T=T_{PSDU}+2×T_{SIFS}+T_{BAR+BA}; or

if there is no acknowledgement response for the MAC frame, that is, ACK Indication=10, calculating the transfer time according to the following formula:

T=T_{PSDU}; or

if the response frame of the MAC frame is a frame other than the ACK frame, a CTS (Clear To Send, Clear To Send) frame, and the BA frame, calculating the transfer time according to the following formula:

T=T_{PSDU}+T_{SIFS}+T_{MAX}_{_{—}}_{PSDU}; where

T_{PSDU} is an actual transfer time of the MAC frame (that is, a time used for transmitting only the MAC frame); T_{SIFS} is a SIFS (Short Inter-Frame Space, short interframe space); T_{ACK} is a transfer time of the ACK frame; T_{BAR+BA} is a transfer time of a BAR (Block Acknowledgement Request, block acknowledgement request) frame and the BA frame; and T_{MAX}_{_{—}}_{PSDU} is a transfer time for transmitting a maximum allowed MAC frame.

Specifically, T_{PSDU}=L/V, where L indicates the frame length of the MAC frame and V indicates the transmission rate of the MAC frame.

Step 2023: Set the NAV value according to the transfer time of the MAC frame.

In specific implementation, if the NAV value does not have a current value, the NAV value may be set according to the transfer time of the MAC frame; if the NAV value has a current value, the NAV value may be set according to a larger value of the current value of the NAV value and the transfer time of the MAC frame.

Step 203: If the data frame received by the device in the first BSS includes the Preamble sequence and the MAC frame, set a NAV value according to a Duration field in a frame header of the MAC frame when the MAC frame can be parsed.

In an implementation manner of this embodiment, step 203 may include: obtaining the transfer time of the MAC frame from the Duration field in the frame header of the MAC frame; and setting the NAV value according to the transfer time of the MAC frame.

In specific implementation, if the NAV value does not have a current value, the NAV value may be set according to the transfer time of the MAC frame; if the NAV value has a current value, the NAV value may be set according to a larger value of the current value of the NAV value and the transfer time of the MAC frame.

Step 204: If the received data frame includes the Preamble sequence and the MAC frame, set a NAV value according to a SIG field in the Preamble sequence when the MAC frame cannot be parsed.

Step 205: Transmit data according to the NAV value. This step is performed after step 202, step 203, or step 204.

In an implementation manner of this embodiment, step 205 may include: if the NAV value is 0, sending the data frame at the second power; if the NAV value is greater than 0, skipping sending the data frame.

Preferably, the sending the data frame at the second power may include: if the device in the first BSS is a long range AP, sending the data frame by using normal transmit power of the long range AP; if the device in the first BSS is a long range STA, sending the data frame by using normal transmit power of the long range STA. The normal transmit power of the long range AP is a fixed value, and the normal transmit power of the long range STA is determined according to a power attenuation situation of a Beacon (beacon) frame sent by a long range AP communicating with the long range STA to the long range STA, where the Beacon frame includes the normal transmit power of the long range AP. The long range AP obtains the power attenuation situation of the Beacon frame according to a difference between the normal transmit power that is of the long range AP and obtained from the Beacon frame and power when the Beacon frame is received.

In another implementation manner of this embodiment, the method may further include: performing physical carrier sense on a channel to obtain a status of the channel. This step is performed before step 205.

Accordingly, step 205 includes: transmitting data according to the status of the channel and the NAV value.

Specifically, the performing physical carrier sense on a channel to obtain a status of the channel may include: if a noise power ratio on the channel is higher than the threshold, determining that the channel is in a busy state; otherwise, determining that the channel is in an idle state.

In still another implementation manner of this embodiment, the method may further include step 200: determining whether the device in the first BSS is a device in the long range BSS or a device in the short range BSS. Step 200 needs to be performed before step 202, step 203, or step 204, but there is no sequence between step 200 and step 201.

In specific implementation, for a device in a BSS, in a case in which a configuration parameter remains unchanged, step 200 generally needs to be performed only once, and is preferably performed before step 201 in this case.

Optionally, step 200 may include: when normal transmit power of the device in the first BSS is higher than the threshold, determining that the device in the first BSS is the device in the long range BSS; or when normal transmit power of the device in the first BSS is lower than the threshold, determining that the device in the first BSS is the device in the short range BSS. The device in the short range BSS acquires the threshold from a Beacon frame broadcasted by the long range AP.

In this embodiment of the present invention, by setting, according to a SIG field in a Preamble sequence, a NAV value used to indicate a transfer time of a MAC frame, the Preamble sequence is sent by a device in a second BSS by using first power, where the first power is higher than second power used for sending the MAC frame, so as to enable a device in a first BSS to obtain the transfer time of the MAC frame. When the first BSS is a long range BSS, the device in the first BSS (long range BSS) may receive the Preamble sequence sent by the device in the second BSS (short range BSS), so as to obtain a data transmission time of the device in the second BSS and set the NAV value according to the data transmission time; therefore, when data is transmitted according to the NAV value, no interference is caused to data transmission of the device in the second BSS, and further, the data transmission of the device in the second BSS does not fail.

### Embodiment 3

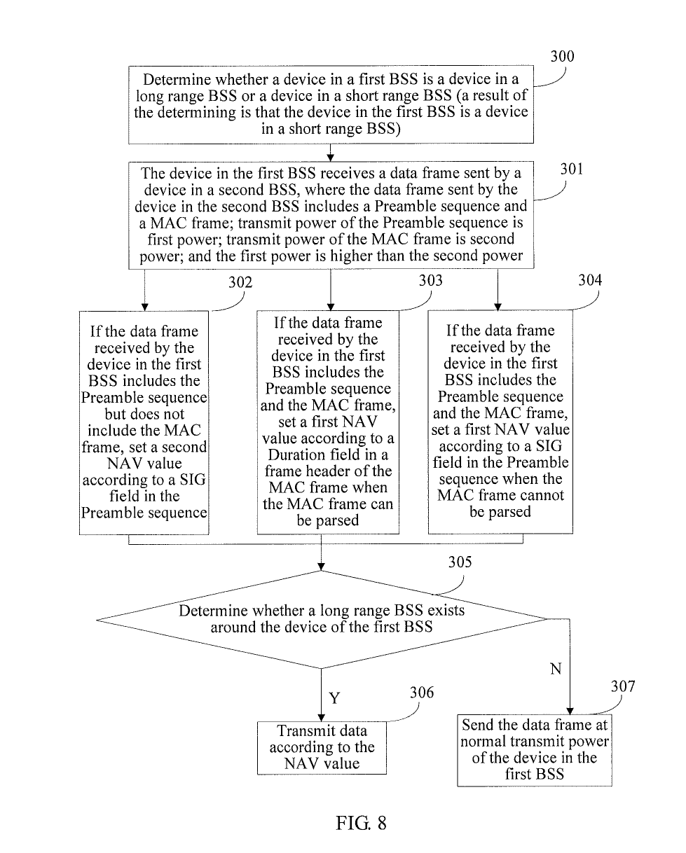

An embodiment of the present invention describes, by using an example in which a device in a first BSS is a device in a short range BSS, the data transmission method provided in Embodiment 1 of the present invention. The method in this embodiment is executed by the device (which may be an AP or a STA) in the first BSS. Referring to FIG. 8, the method includes:

Step 301: A device in a first BSS receives a data frame sent by a device in a second BSS.

In an embodiment, the second BSS may be a short range BSS, where normal transmit power of an AP in the short range BSS is lower than a threshold. The data frame sent by the device in the second BSS includes a Preamble sequence and a MAC frame. Transmit power of the Preamble sequence is first power, and transmit power of the MAC frame is second power. That is, the device in the second BSS sends the Preamble sequence of the data frame at the first power, and sends the MAC frame of the data frame at the second power. The first power is higher than the second power.

Step 302: If the data frame received by the device in the first BSS includes the Preamble sequence but does not include the MAC frame, set a second NAV value according to a SIG field in the Preamble sequence.

Step 303: If the data frame received by the device in the first BSS includes the Preamble sequence and the MAC frame, set a first NAV value according to a Duration field in a frame header of the MAC frame when the MAC frame can be parsed.

Optionally, step 303 may be the same as step 203 in Embodiment 2, and details are not described herein again.

Step 304: If the data frame received by the device in the first BSS includes the Preamble sequence and the MAC frame, set a first NAV value according to a SIG field in the Preamble sequence when the MAC frame cannot be parsed.

Optionally, step 304 may be the same as step 202 in Embodiment 2, and details are not described herein again.

Step 305: Determine whether a long range BSS exists around the device in the first BSS. If the long range BSS exists around the device in the first BSS, step 306 is performed; if the long range BSS does not exist around the device in the first BSS, step 307 is performed. This step is performed after step 302, step 303, or step 304.

In specific implementation, the determining whether a long range BSS exists around the device in the first BSS may include:

receiving a Beacon frame broadcasted by an AP and acquiring normal transmit power of the AP from the Beacon frame; comparing the normal transmit power of the AP with the threshold; and if normal transmit power of at least one AP is higher than the threshold, determining that the long range BSS exists around the device in the first BSS; otherwise, determining that the long range BSS does not exist around the device in the first BSS. The threshold is obtained from the Beacon frame broadcasted by the long range AP.

Step 306: Transmit data according to the NAV value.

As previously mentioned, in this embodiment, the NAV value includes the first NAV value and the second NAV value. The first NAV value is set according to the SIG field in the Preamble sequence or set according to the Duration field in the frame header of the MAC frame, and the second NAV value is set according to the SIG field in the Preamble sequence. Both the first NAV value and the second NAV value are used to indicate the transfer time of the MAC frame.

In an implementation manner of this embodiment, step 306 may include: if the first NAV value is greater than 0, skipping sending the data frame; if the first NAV value is 0 and the second NAV value is 0, sending the Preamble sequence at the first power, and sending the MAC frame at the second power; if the first NAV value is 0, and the second NAV value is greater than 0, sending the data frame at the second power.

In this embodiment, the first power may equal the sum of the second power and a predetermined value, where the predetermined value is greater than 0.

In specific implementation, the predetermined value may be a difference between the normal transmit power of the long range AP and the normal transmit power of the short range AP, where the normal transmit power of the long range AP is higher than the threshold.

Preferably, the sending the MAC frame at the second power or sending the data frame at the second power may include:

If the device in the first BSS is a short range AP, sending the MAC frame by using normal transmit power of the short range AP or sending the data frame by using normal transmit power of the short range AP; if the device in the first BSS is a short range STA, sending the MAC frame by using normal transmit power of the short range STA or sending the data frame by using normal transmit power of the short range STA. The normal transmit power of the short range AP is a fixed value, and the normal transmit power of the short range STA is determined according to a power attenuation situation of a Beacon frame sent by a short range AP communicating with the short range STA to the short range STA, where the Beacon frame includes the normal transmit power of the short range AP. The short range STA obtains the power attenuation situation of the Beacon frame according to a difference between the normal transmit power that is of the short range AP and obtained from the Beacon frame and power when the Beacon frame is received.

In another implementation manner of this embodiment, step 306 may further include: if the first NAV value is 0 and the second NAV value is greater than 0 and a time required for the second NAV value to decrease to 0 is less than a data transmission time of the device in the first BSS, after the second NAV value decreases to 0, sending the Preamble sequence at the first power and sending the MAC frame at the second power.

Preferably, when the Preamble sequence is sent at the first power, a bit, such as an R bit, in the SIG field may be used to indicate that the Preamble sequence is sent at the first power. For example, that a value on the R bit is 1 indicates that the Preamble sequence is sent at the first power, and that a value on the R bit is 0 indicates that the Preamble sequence is sent at the second power.

In still another implementation manner of this embodiment, a Preamble sequence of a response frame of the MAC frame may be sent at the second power. For example, when the response frame of the MAC frame is an ACK frame, that is, ACK Indication=00 in the SIG field in the Preamble sequence, the Preamble sequence of the ACK frame is sent at the second power. For another example, when the response frame of the MAC frame is a BA frame, that is, ACK Indication=01 in the SIG field in the Preamble sequence, the Preamble sequence of the BA frame and a BAR frame is sent at the second power.

Step 307: Transmit the data frame at the second power.

In still another implementation manner of this embodiment, the method may further include: performing physical carrier sense on a channel to obtain a status of the channel. This step is performed before step 306.

Accordingly, step 306 includes: transmitting data according to the status of the channel and the NAV value.

Specifically, the performing physical carrier sense on a channel to obtain a status of the channel may be the same as the performing physical carrier sense on a channel to obtain a status of the channel in Embodiment 2, and details are not described herein again.

In still another implementation manner of this embodiment, the method may further include step 300: determining whether the device in the first BSS is a device in the long range BSS or a device in the short range BSS. Step 300 needs to be performed before step 302, step 303, or step 304, but there is no sequence between step 300 and step 301.

In specific implementation, for a device in a BSS, in a case in which a configuration parameter remains unchanged, step 300 generally needs to be performed only once, and is preferably performed before step 301 in this case.

Optionally, step 300 may be the same as step 200 in Embodiment 2, and details are not described herein again.

It should be noted that, in Embodiment 1, Embodiment 2, and Embodiment 3, before performing virtual carrier sense, the device in the first BSS receives the Beacon frame broadcasted by the long range AP and acquires the threshold and the predetermined value (the difference between the normal transmit power of the device in the long range BSS and the normal transmit power of the device in the short range BSS) from the Beacon frame; the device in the first BSS adjusts an AGC (Automatic Gain Control, automatic gain control) parameter according to the predetermined value, so that power after the data is processed is consistent.

In this embodiment of the present invention, by setting, according to a SIG field in a Preamble sequence, a NAV value used to indicate a transfer time of a MAC frame, the Preamble sequence is sent by a device in a second BSS by using first power, where the first power is than second power used for sending the MAC frame, so as to enable a device in a first BSS to obtain the transfer time of the MAC frame. When the first BSS is a short range BSS, the device in the second BSS sends the Preamble sequence at the first power, and sends the MAC frame at the second power, where the first power is higher than the second power; therefore, the device in the second BSS suppresses data transmission of the device in the first BSS (short range BSS) only when sending the Preamble sequence, and does not suppress data transmission of the device in the first BSS when sending the MAC frame, thereby avoiding a problem in the prior art that an increase in transmit power of an entire data frame results in suppression of concurrent data transmission of devices in two short range BSSs (the first BSS and the second BSS) that do not overlap.

### Embodiment 4

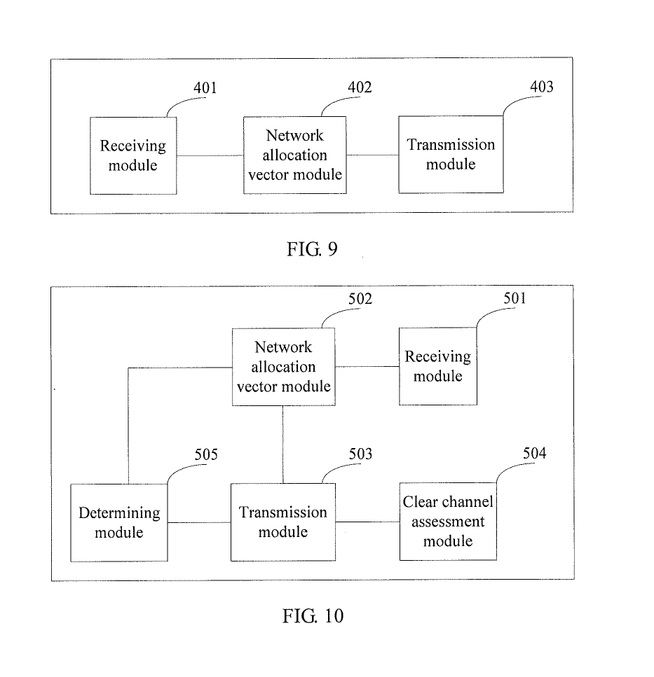

An embodiment of the present invention provides a data transmission device, applied to the data transmission method provided in Embodiment 1. Referring to FIG. 9, the device includes:

a receiving module 401, configured to receive a data frame sent by a device in a second BSS, where the second BSS may be a short range BSS, and normal transmit power of an AP in the short range BSS is lower than a threshold, where the data frame sent by the device in the second BSS includes a Preamble sequence and a MAC frame; transmit power of the Preamble sequence is first power; transmit power of the MAC frame is second power; and the first power is higher than the second power;

a NAV setting module 402, configured to: when the data frame received by the receiving module 401 includes the Preamble sequence but does not include the MAC frame, set a NAV value according to a SIG field in the Preamble sequence; and

a transmission module 403, configured to transmit data according to the NAV value that is set by the NAV setting module 402.

In this embodiment of the present invention, by setting, according to a SIG field in a Preamble sequence, a NAV value used to indicate a transfer time of a MAC frame, the Preamble sequence is sent by a device in a second BSS by using first power, where the first power is higher than second power used for sending the MAC frame, so as to enable a device in a first BSS to obtain the transfer time of the MAC frame. When the first BSS is a long range BSS, the device in the first BSS (long range BSS) may receive the Preamble sequence sent by the device in the second BSS (short range BSS), so as to obtain a data transmission time of the device in the second BSS and set the NAV value according to the data transmission time; therefore, when data is transmitted according to the NAV value, no interference is caused to data transmission of the device in the second BSS, and further, the data transmission of the device in the second BSS does not fail. When the first BSS is a short range BSS, the device in the second BSS sends the Preamble sequence at the first power, and sends the MAC frame at the second power, where the first power is higher than the second power; therefore, the device in the second BSS suppresses data transmission of the device in the first BSS (short range BSS) only when sending the Preamble sequence, and does not suppress data transmission of the device in the first BSS when sending the MAC frame, thereby avoiding a problem in the prior art that an increase in transmit power of an entire data frame results in suppression of concurrent data transmission of devices in two short range BSSs (the first BSS and the second BSS) that do not overlap.

### Embodiment 5

An embodiment of the present invention describes, by using an example in which the device is a device in a long range BSS, the data transmission device provided in Embodiment 4 of the present invention, which is applied to the data transmission method provided in Embodiment 2. Referring to FIG. 10, the device includes:

a receiving module 501, configured to receive a data frame sent by a device in a second BSS, where the second BSS may be a short range BSS, and normal transmit power of an AP in the short range BSS is lower than a threshold, where the data frame sent by the device in the second BSS includes a Preamble sequence and a MAC frame; transmit power of the Preamble sequence is first power; transmit power of the MAC frame is second power; and the first power is higher than the second power;

a NAV setting module 502, configured to: when the data frame received by the receiving module 501 includes the Preamble sequence but does not include the MAC frame, set a NAV value according to a SIG field in the Preamble sequence; and

a transmission module 503, configured to transmit data according to the NAV value that is set by the NAV setting module 502.

It should be noted that, in this embodiment, the NAV value includes a first NAV value.

In an implementation manner of this embodiment, the NAV setting module 502 may include:

an obtaining unit, configured to obtain, from the SIG field, a frame length and a transmission rate that are of the MAC frame;

a calculating unit, configured to calculate a transfer time of the MAC frame according to the frame length and the transmission rate that are of the MAC frame and obtained by the obtaining unit; and

a setting unit, configured to set a NAV value according to the transfer time that is of the MAC frame and obtained by the calculating unit.

In this embodiment, when the NAV value does not have a current value, the NAV value may be set according to the transfer time of the MAC frame; when the NAV value has a current value, the NAV value may be set according to a larger value of the current value of the NAV value and the transfer time of the MAC frame.

Optionally, the obtaining unit may be configured to obtain the transmission rate of the MAC frame from a field indicating a transmission rate in the SIG field; obtain a length of the DATA field from a field indicating a length of transmitted data in the SIG field; and obtain the frame length of the MAC frame according to the length of the DATA field.

Optionally, the calculating unit may be configured to calculate the transfer time according to the following formula:

T=L/V, where

L indicates the frame length of the MAC frame and V indicates the transmission rate of the MAC frame.

Preferably, the calculating unit may be configured to determine a corresponding frame of the MAC frame according to an ACK Indication field in the SIG field; and when the response frame of the MAC frame is an ACK frame, that is, ACK Indication=00, calculate the transfer time according to the following formula:

T=T_{PSDU}+T_{SIFS}+T_{ACK}; or

when the response frame of the MAC frame is a BA frame, that is, ACK Indication=01, calculate the transfer time according to the following formula:

T=T_{PSDU}+2×T_{SIFS}+T_{BAR+BA}; or

when there is no acknowledgement response for the MAC frame, that is, ACK Indication=10, calculate the transfer time according to the following formula:

T=T_{PSDU}; or

when the response frame of the MAC frame is a frame other than the ACK frame, a CTS frame, and the BA frame, calculate the transfer time according to the following formula:

T=T_{PSDU}+T_{SIFS}+T_{MAX}_{_{—}}_{PSDU}; where

T_{PSDU} is an actual transfer time of the Medium Access Control frame; T_{PSDU}=L/V, where L indicates the frame length of the MAC frame and V indicates the transmission rate of the MAC frame; T_{SIFS} is a SIFS; T_{ACK} is a transfer time of the ACK frame; T_{BAR+BA} is a transfer time of a BAR frame and the BA frame; and T_{MAX}_{_{—}}_{PSDU} is a transfer time for transmitting a maximum allowed PSDU, that is, MAC frame.

In an implementation manner of this embodiment, the NAV setting module 502 may be further configured to: when the data frame received by the receiving module 501 includes the Preamble sequence and the MAC frame, and the MAC frame can be parsed, set a NAV value according to a Duration field in a frame header of the MAC frame; when the data frame received by the receiving module 501 includes the Preamble sequence and the MAC frame, and the MAC cannot be parsed, set a NAV value according to a SIG field in the Preamble sequence.

In this embodiment, if the NAV value does not have a current value, the NAV value may be set according to the transfer time of the MAC frame; if the NAV value has a current value, the NAV value may be set according to a larger value of the current value of the NAV value and the transfer time of the MAC frame.

In another implementation manner of this embodiment, the transmission module 503 may be configured to: when the NAV value is 0, send the data frame at the second power; when the NAV value is greater than 0, skip sending the data frame.

In still another implementation manner of this embodiment, the device may further include a clear channel assessment module 504, configured to perform physical carrier sense on a channel to obtain a status of the channel.

Accordingly, the transmission module 503 is configured to transmit data according to the status that is of the channel and obtained by the clear channel assessment module 504 and the NAV value that is set by the NAV setting module 502.

Specifically, the clear channel assessment module 504 may be configured to: when a noise power ratio on the channel is higher than a threshold, determine that the channel is in a busy state; otherwise, determine that the channel is in an idle state.

In still another implementation manner of this embodiment, the device may further include a determining module 505, configured to determine whether the device is a device in the long range BSS or a device in the short range BSS.

Optionally, the determining module 505 may be configured to: when normal transmit power of the device is higher than the threshold, determine that the device is the device in the long range BSS; or when normal transmit power of the device is lower than the threshold, determine that the device is the device in the short range BSS. The device in the short range BSS may acquire the threshold from a Beacon frame broadcasted by the long range AP.

In this embodiment of the present invention, by setting, according to a SIG field in a Preamble sequence, a NAV value used to indicate a transfer time of a MAC frame, the Preamble sequence is sent by a device in a second BSS by using first power, where the first power is higher than second power used for sending the MAC frame, so as to enable a device in a first BSS to obtain the transfer time of the MAC frame. When the first BSS is a long range BSS, the device in the first BSS (long range BSS) may receive the Preamble sequence sent by the device in the second BSS (short range BSS), so as to obtain a data transmission time of the device in the second BSS and set the NAV value according to the data transmission time; therefore, when data is transmitted according to the NAV value, no interference is caused to data transmission of the device in the second BSS, and further, the data transmission of the device in the second BSS does not fail.

### Embodiment 6

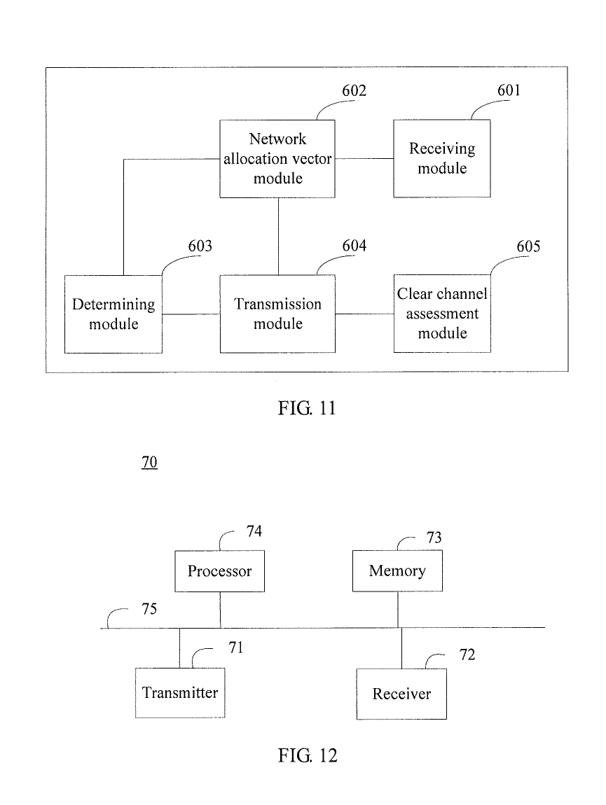

An embodiment of the present invention describes, by using an example in which the device is a device in a short range BSS, the data transmission device provided in Embodiment 4 of the present invention, which is applied to the data transmission method provided in Embodiment 3. Referring to FIG. 11, the device includes:

a receiving module 601, configured to receive a data frame sent by a device in a second BSS, where the second BSS may be a short range BSS, and normal transmit power of an AP in the short range BSS is lower than a threshold, where the data frame sent by the device in the second BSS includes a Preamble sequence and a MAC frame; transmit power of the Preamble sequence is first power; transmit power of the MAC frame is second power; and the first power is higher than the second power;

a NAV setting module 602, configured to: when the data frame received by the receiving module 601 includes the Preamble sequence but does not include the MAC frame, set a second NAV value according to a SIG field in the Preamble sequence;

a determining module 603, configured to determine whether a long range BSS exists around the device; and

a transmission module 604, configured to transmit data according to a determining result obtained by the determining module 603; and when the determining result obtained by the determining module 603 is that the long range BSS exists around the device, configured to transmit data according to the NAV value obtained by the NAV setting module 602; or when the determining result obtained by the determining module 603 is that the long range BSS does not exist around the device, configured to send the data frame by using the normal transmit power of the device.

It should be noted that, in this embodiment, the device in the short range BSS sets the NAV value according to the SIG field in the Preamble sequence, where the NAV value includes the first NAV value and the second NAV value.

In an implementation manner of this embodiment, the NAV setting module 602 may be further configured to: when the data frame received by the receiving module 601 includes the Preamble sequence and the MAC frame, and the MAC frame can be parsed, set a first NAV value according to a Duration field in a frame header of the MAC frame; when the data frame received by the receiving module 601 includes the Preamble sequence and the MAC frame, and the MAC cannot be parsed, set a first NAV value according to the SIG field in the Preamble sequence.

In specific implementation, the determining module 603 may include:

an acquiring unit, configured to receive a Beacon frame broadcasted by an AP and acquire normal transmit power of the AP from the Beacon frame; and

a comparing unit, configured to compare, with the threshold, the normal transmit power of the AP acquired by the acquiring unit; and, when normal transmit power of at least one AP is higher than the threshold, determine that the long range BSS exists around the device; otherwise, determine that the long range BSS does not exist around the device.

In this embodiment, the threshold may be obtained from the Beacon frame broadcasted by the long range AP.

In an implementation manner of this embodiment, the transmission module 604 may be configured to: when the first NAV value is greater than 0, skip sending the data frame; when the first NAV value is 0 and the second NAV value is 0, send the Preamble sequence at the first power, and send the MAC frame at the second power; or when the first NAV value is 0, and the second NAV value is greater than 0, send the data frame at the second power.

Preferably, the transmission module 604 may be configured to: when the first NAV value is 0 and the second NAV value is 0, send the Preamble sequence by using the sum of the second power and a predetermined value, and send the MAC frame at the second power, where the predetermined value is greater than 0.

Preferably, the predetermined value may be a difference between the normal transmit power of the long range AP and the normal transmit power of the short range AP.

Preferably, the transmission module 604 may be further configured to use a bit in the signal field to indicate that the preamble sequence is sent at the first power.

In another implementation manner of this embodiment, the transmission module 604 may be further configured to: when the first NAV value is 0 and the second NAV value is greater than 0 and a time required for the second NAV value to decrease to 0 is less than a data transmission time of the device in the first BSS, after the second NAV value decreases to 0, send the Preamble sequence at the first power and send the MAC frame at the second power.

In still another implementation manner of this embodiment, the device further includes a clear channel assessment module 605, configured to perform physical carrier sense on a channel to obtain a status of the channel.

Accordingly, the transmission module 604 is configured to transmit data according to the status that is of the channel and obtained by the clear channel assessment module 605 and the NAV value that is set by the NAV setting module 602.

In still another implementation manner of this embodiment, the determining module 605 is further configured to determine whether the device is a device in the long range BSS or a device in the short range BSS.

In this embodiment of the present invention, by setting, according to a SIG field in a Preamble sequence, a NAV value used to indicate a transfer time of a MAC frame, the Preamble sequence is sent by a device in a second BSS by using first power, where the first power is higher than second power used for sending the MAC frame, so as to enable a device in a first BSS to obtain the transfer time of the MAC frame. When the first BSS is a short range BSS, the device in the second BSS sends the Preamble sequence at the first power, and sends the MAC frame at the second power, where the first power is higher than the second power; therefore, the device in the second BSS suppresses data transmission of the device in the first BSS (short range BSS) only when sending the Preamble sequence, and does not suppress data transmission of the device in the first BSS when sending the MAC frame, thereby avoiding a problem in the prior art that an increase in transmit power of an entire data frame results in suppression of concurrent data transmission of devices in two short range BSSs (the first BSS and the second BSS) that do not overlap.

### Embodiment 7

An embodiment of the present invention provides a data transmission device, where the device may be a computer or a server in a specific implementation manner, as shown in FIG. 12.

The device generally includes a transmitter 71, a receiver 72, a memory 73, a processor 74, and the like part. A person skilled in the art may understand that the structure shown in FIG. 12 does not constitute a limitation on the device; the device may include more or less parts than those shown in the figure, or combine some parts or different part arrangements.

The following introduces components of a computer 70 in detail with reference to FIG. 12.

The receiver 72 is configured to receive a data frame sent by a device in a second BSS.

The transmitter 71 is configured to transmit data under control of the processor 74.

The memory 73 may be configured to store a software program and an application module. By running the software program and the application module that are stored in the memory 73, the processor 74 executes various functional applications of the computer 70 and performs data processing. The memory 73 may mainly include a storage program area and a storage data area, where the storage program area may store an operating system, an application program required by at least one function, and the like, and the storage data area may store data (such as a NAV value) created according to processing performed by the computer 70, and the like. In addition, the memory 73 may include a high-speed RAM (Random Access Memory, random access memory), and may further include a non-volatile memory (non-volatile memory), for example, at least one disk storage component, a flash memory component, or another volatile solid state storage component.

A communications bus 75 is configured to implement connection and communication between the processor 74, the memory 73, the transmitter 71, and the receiver 72.

Specifically, by running or executing the software program and the application module that are stored in the memory 73, and by invoking data stored in the memory 73, the processor 74 may implement, when the data frame received by the receiver 72 includes a Preamble sequence but does not include a MAC frame, setting a NAV value according to a SIG field in the Preamble sequence.

Further, the processor 74 may be configured to: when the device is a device in a short range BSS, set a second NAV value according to the SIG field in the Preamble sequence.

Optionally, the processor 74 may be further configured to: if the received data frame includes a Preamble sequence and a MAC frame, set a first NAV value according to a Duration field in a frame header of the MAC frame when the MAC frame can be parsed; and set a first NAV value according to the SIG field in the Preamble sequence when the MAC frame cannot be parsed.

Specifically, when the device is a device in a short range BSS, the receiver 72 is further configured to receive a Beacon frame broadcasted by an AP and acquire normal transmit power of the AP from the Beacon frame.

Accordingly, the processor 74 may implement determining whether a long range BSS exists around the device.

Further, the transmitter 71 is configured to: when the long range BSS exists around the device, transmit data according to the NAV value under control of the processor 74; when the long range BSS does not exist around the device, send the data frame at the second power under control of the processor 74, where the second power may be normal transmit power of the device.

Specifically, when the device is the device in the long range BSS, that the transmitter 71 transmits data according to the NAV value under control of the processor 74 includes: when the NAV value is 0, sending the data frame at the second power; when the NAV value is greater than 0, skipping sending the data frame.

Specifically, when the device is the device in the short range BSS, that the transmitter 71 transmits data according to the NAV value under control of the processor 74 includes: when the first NAV value is greater than 0, skipping sending the data frame; when the first NAV value is 0 and the second NAV value is 0, sending the Preamble sequence at the first power, and sending the MAC frame at the second power, where the first power is higher than the second power; or when the first NAV value is 0, and the second NAV value is greater than 0, sending the data frame at the second power. The first power may be the sum of the second power and a predetermined value, where the predetermined value is greater than 0. For the device in the short range BSS, both the predetermined value and the threshold are obtained from the Beacon frame that is broadcasted by the long range AP and received by the receiver 72.

Further, when the device is the device in the short range BSS, that the transmitter 71 transmits data according to the NAV value under control of the processor 74 further includes: when the first NAV value is 0 and the second NAV value is greater than 0 and a time required for the second NAV value to decrease to 0 is less than a data transmission time of the device in the first BSS, after the second NAV value decreases to 0, sending the Preamble sequence at the first power and sending the MAC frame at the second power.

Preferably, the receiver 72 may be further configured to perform physical carrier sense on a channel to obtain a status of the channel.

Accordingly, the transmitter 71 may be configured to transmit data according to the status of the channel and the NAV value under control of the processor 74.

Preferably, the receiver 72 may be configured to receive the threshold carried in the Beacon frame that is broadcasted by the long range AP.

Accordingly, the processor 74 may implement determining whether the device is the device in the long range BSS or the device in the short range BSS.

Further, the processor 74 may implement: when normal transmit power of the device is higher than the threshold, determining that the device is the device in the long range BSS; or when normal transmit power of the device is lower than the threshold, determining that the device is the device in the short range BSS.

In this embodiment of the present invention, by setting, according to a SIG field in a Preamble sequence, a NAV value used to indicate a transfer time of a MAC frame, the Preamble sequence is sent by a device in a second BSS by using first power, where the first power is higher than second power used for sending the MAC frame, so as to enable a device in a first BSS to obtain the transfer time of the MAC frame. When the first BSS is a long range BSS, the device in the first BSS (long range BSS) may receive the Preamble sequence sent by the device in the second BSS (short range BSS), so as to obtain a data transmission time of the device in the second BSS and set the NAV value according to the data transmission time; therefore, when data is transmitted according to the NAV value, no interference is caused to data transmission of the device in the second BSS, and further, the data transmission of the device in the second BSS does not fail. When the first BSS is a short range BSS, the device in the second BSS sends the Preamble sequence at the first power, and sends the MAC frame at the second power, where the first power is higher than the second power; therefore, the device in the second BSS suppresses data transmission of the device in the first BSS (short range BSS) only when sending the Preamble sequence, and does not suppress data transmission of the device in the first BSS when sending the MAC frame, thereby avoiding a problem in the prior art that an increase in transmit power of an entire data frame results in suppression of concurrent data transmission of devices in two short range BSSs (the first BSS and the second BSS) that do not overlap.

It should be noted that, when the data transmission device provided in the foregoing embodiments is transmitting data, description is performed only by using the division of the foregoing functional modules as an example. In actual application, the foregoing functions can be allocated to different modules and implemented according to a requirement, that is, an inner structure of a device is divided into different function modules to implement all or some of the functions described above. In addition, the data transmission method embodiments provided in the foregoing embodiments pertain to a same concept. For a specific implementation process, reference may be made to the method embodiments, and details are not described herein again.

The sequence numbers of the foregoing embodiments of the present invention are merely for illustrative purposes, and are not intended to indicate priorities of the embodiments.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A data transmission method, wherein the method comprises:
receiving, by a device in a first basic service set, a data frame sent by a device in a second basic service set, wherein the data frame sent by the device in the second basic service set comprises a preamble sequence and a Medium Access Control frame; transmit power of the preamble sequence is first power; transmit power of the Medium Access Control frame is second power; and the first power is higher than the second power;
if the data frame received by the device in the first basic service set comprises the preamble sequence but does not comprise the Medium Access Control frame, setting a network allocation vector value according to a signal field in the preamble sequence; and
transmitting data according to the network allocation vector value.

2. The method according to claim 1, wherein the setting a network allocation vector value according to a signal field in the preamble sequence comprises:
obtaining, from the signal field, a frame length and a transmission rate of the Medium Access Control frame;
calculating a transfer time of the Medium Access Control frame according to the frame length and the transmission rate of the Medium Access Control frame; and
setting the network allocation vector value according to the transfer time of the Medium Access Control frame.

3. The method according to claim 2, wherein the calculating a transfer time of the Medium Access Control frame according to the frame length and the transmission rate of the Medium Access Control frame comprises:
determining a response frame of the Medium Access Control frame according to an acknowledgement indication field in the signal field; and
if the response frame of the Medium Access Control frame is an acknowledgement frame, calculating the transfer time according to the following formula:
T=T_{PSDU}+T_{SIFS}+T_{ACK}; or
if the response frame of the Medium Access Control frame is a block acknowledgement frame, calculating the transfer time according to the following formula:
T=T_{PSDU}+2×T_{SIFS}+T_{BAR+BA}; or
if there is no acknowledgement response for the Medium Access Control frame, calculating the transfer time according to the following formula:
T=T_{PSDU}; or
if the response frame of the Medium Access Control frame is a frame other than the acknowledgement frame, a Clear To Send frame, and the block acknowledgement frame, calculating the transfer time according to the following formula:
T=T_{PSDU}+T_{SIFS}+T_{MAX}_{_{—}}_{PSDU}; wherein
T_{PSDU} is an actual transfer time of the Medium Access Control frame; T_{SIFS} is a short interframe space; T_{ACK} is a transfer time of the acknowledgement frame; T_{BAR+BA} is a transfer time of a block acknowledgement request frame and the block acknowledgement frame; and T_{MAX}_{_{—}}_{PSDU} is a time for transmitting a maximum allowed Medium Access Control frame.

4. The method according to claim 1, wherein when normal transmit power of an access point in the first basic service set is higher than a threshold, the network allocation vector value comprises a first network allocation vector value, and the setting a network allocation vector value according to a signal field in the preamble sequence comprises:
setting the first network allocation vector value according to the signal field in the preamble sequence; and
the method further comprises:
if the data frame received by the device in the first basic service set comprises the preamble sequence and the Medium Access Control frame, setting the first network allocation vector value according to a duration field in a frame header of the Medium Access Control frame.

5. The method according to claim 1, wherein when normal transmit power of an access point in the first basic service set is lower than a threshold, the network allocation vector value comprises a first network allocation vector value and a second network allocation vector value, and the method further comprises:
if the data frame received by the device in the first basic service set comprises the preamble sequence and the Medium Access Control frame, setting the first network allocation vector value according to a duration field in a frame header of the Medium Access Control frame; and
the setting a network allocation vector value according to a signal field in the preamble sequence comprises:
setting the second network allocation vector value according to the signal field in the preamble sequence.

6. The method according to claim 5, wherein when the data frame received by the device in the first basic service set comprises the preamble sequence and the Medium Access Control frame, before the setting the first network allocation vector value according to a duration field in a frame header of the Medium Access Control frame, the method further comprises:
if the Medium Access Control frame can be parsed, setting the first network allocation vector value according to the duration field in the frame header of the Medium Access Control frame; and
if the Medium Access Control frame cannot be parsed, setting the first network allocation vector value according to the signal field in the preamble sequence.

7. The method according to claim 5, wherein the transmitting data according to the network allocation vector value comprises:
if the first network allocation vector value is greater than 0, skipping sending the data frame; and
if the first network allocation vector value is 0 and the second network allocation vector value is 0, sending the preamble sequence at the first power and sending the Medium Access Control frame at the second power.

8. The method according to claim 7, wherein the first power is equal to the sum of the second power and a predetermined value, wherein the predetermined value is greater than 0.

9. The method according to claim 7, before the sending the preamble sequence at the first power, further comprising:
using a bit in the signal field to indicate that the preamble sequence is sent at the first power.

10. The method according to claim 7, wherein the transmitting data according to the network allocation vector value further comprises:
if the first network allocation vector value is 0, the second network allocation vector value is greater than 0, and a time required for the second network allocation vector value to decrease to 0 is greater than or equal to a data transmission time of the device in the first basic service set, sending the data frame at the second power; or
if the first network allocation vector value is 0, the second network allocation vector value is greater than 0, and a time required for the second network allocation vector value to decrease to 0 is less than a data transmission time of the device in the first basic service set, after the second network allocation vector value decreases to 0, sending the preamble sequence at the first power, and sending the Medium Access Control frame at the second power.

11. A data transmission device, wherein the device comprises:
a receiving module, configured to receive a data frame sent by a device in a second basic service set, wherein the data frame sent by the device in the second basic service set comprises a preamble sequence and a Medium Access Control frame;
transmit power of the preamble sequence is first power; transmit power of the Medium Access Control frame is second power; and the first power is higher than the second power;
a network allocation vector setting module, configured to: when the data frame received by the receiving module comprises the preamble sequence but does not comprise the Medium Access Control frame, set a network allocation vector value according to a signal field in the preamble sequence; and
a transmission module, configured to transmit data according to the network allocation vector value that is set by the network allocation vector setting module.

12. The device according to claim 11, wherein the network allocation vector setting module comprises:
an obtaining unit, configured to obtain a frame length and a transmission rate of the Medium Access Control frame from the signal field;
a calculating unit, configured to calculate a transfer time of the Medium Access Control frame according to the frame length and the transmission rate of the Medium Access Control frame obtained by the obtaining unit; and
a setting unit, configured to set the network allocation vector value according to the transfer time of the Medium Access Control frame obtained by the calculating unit.

13. The device according to claim 12, wherein the calculating unit is configured to:
determine a response frame of the Medium Access Control frame according to an acknowledgement indication field in the signal field; and
when the response frame of the Medium Access Control frame is an acknowledgement frame, calculate the transfer time according to the following formula:
T=T_{PSDU}+T_{SIFS}+T_{ACK}; or
when the response frame of the Medium Access Control frame is a block acknowledgement frame, calculate the transfer time according to the following formula:
T=T_{PSDU}+2×T_{SIFS}+T_{BAR+BA}; or
when there is no acknowledgement response for the Medium Access Control frame, calculate the transfer time according to the following formula:
T=T_{PSDU}; or
when the response frame of the Medium Access Control frame is a frame other than the acknowledgement frame, a Clear To Send frame, and the block acknowledgement frame, calculate the transfer time according to the following formula:
T=T_{PSDU}+T_{SIFS}+T_{MAX}_{_{—}}_{PSDU}; wherein
T_{PSDU} is an actual transfer time of the Medium Access Control frame; T_{SIFS} is a short interframe space; T_{ACK} is a transfer time of the acknowledgement frame; T_{BAR+BA} is a transfer time of a block acknowledgement request frame and the block acknowledgement frame; and T_{MAX}_{_{—}}_{PSDU} is a time for transmitting a maximum allowed Medium Access Control frame.

14. The device according to a claim 11, wherein the network allocation vector setting module is further configured to:
when normal transmit power of an access point in the first basic service set is higher than the threshold, and the data frame received by the receiving module comprises the preamble sequence but does not comprise the Medium Access Control frame, set a first network allocation vector value according to the signal field in the preamble sequence; or
when normal transmit power of an access point in the first basic service set is higher than the threshold, and the data frame received by the receiving module comprises the preamble sequence and the Medium Access Control frame, set the first network allocation vector value according to a duration field in a frame header of the Medium Access Control frame.

15. The device according to claim 11, wherein the network allocation vector setting module is further configured to:
when normal transmit power of an access point in the first basic service set is lower than the threshold, and the data frame received by the receiving module comprises the preamble sequence and the Medium Access Control frame, set the first network allocation vector value according to a duration field in a frame header of the Medium Access Control frame; or
when normal transmit power of an access point in the first basic service set is lower than the threshold, and the received data frame comprises the preamble sequence but does not comprise the Medium Access Control frame, set a second network allocation vector value according to the signal field in the preamble sequence.

16. The device according to claim 15, wherein the network allocation vector setting module is further configured to:
when the data frame received by the receiving module comprises the preamble sequence and the Medium Access Control frame, before the setting the first network allocation vector value according to a duration field in a frame header of the Medium Access Control frame,
when the Medium Access Control frame can be parsed, set the first network allocation vector value according to the duration field in the frame header of the Medium Access Control frame; or
when the Medium Access Control frame cannot be parsed, set the first network allocation vector value according to the signal field in the preamble sequence.

17. The device according to claim 15, wherein the transmission module is configured to:
when the first network allocation vector value is greater than 0, skip sending the data frame; or
when the first network allocation vector value is 0 and the second network allocation vector value is 0, send the preamble sequence at the first power and send the Medium Access Control frame at the second power.

18. The device according to claim 17, wherein the transmission module is configured to:
when the first network allocation vector value is 0 and the second network allocation vector value is 0, send the preamble sequence by using the sum of the second power and a predetermined value, and send the Medium Access Control frame at the second power, wherein the predetermined value is greater than 0.

19. The device according to claim 17, wherein the transmission module is further configured to:
use a bit in the signal field to indicate that the preamble sequence is sent at the first power.

20. The device according to claim 17, wherein the transmission module is further configured to:
when the first network allocation vector value is 0, the second network allocation vector value is greater than 0, and a time required for the second network allocation vector value to decrease to 0 is greater than or equal to a data transmission time of the device in the first basic service set, send the data frame at the second power; or
when the first network allocation vector value is 0, the second network allocation vector value is greater than 0, and a time required for the second network allocation vector value to decrease to 0 is less than a data transmission time of the device in the first basic service set, after the second network allocation vector value decreases to 0, send the preamble sequence at the first power, and send the Medium Access Control frame at the second power.
